(19) United States
(12) Patent Application Publication
(10) Pub. No.: US 2012/0324393 A1
(43) Pub. Date: Dec. 20, 2012

(54) NETWORK BASED ELECTRONIC BOOK USAGE TRACKING SYSTEM AND METHOD

(75) Inventors: Ernest V. Mbenkum, Toronto (CA); Mark Hempel, Edina, MN (US)

(73) Assignee: LIGHTCODE, INC., Toronto (CA)

(21) Appl. No.: 13/163,797

(22) Filed: Jun. 20, 2011

(51) Int. Cl. G06F 3/048

(52) U.S. Cl. 715/776

(57) ABSTRACT

A system and method is presented for the web-based reading of books. Users of the system access books page-by-page through a computerized web server, with a social community oriented around each book being presented in conjunction with the book. Data is maintained in a database relating to user, author, and publisher additions to the book-oriented social community. Page clicks by users reading the book are also monitored and analyzed, allowing the system to identify users that read every page of the book, and also identify the page where users stopped reading the book.

### RELATED APPLICATIONS

The present application is related to the co-pending application entitled “Page-Based Electronic Book Reading with Community Interaction System and Method,” attorney docket number 4700, filed on the same date and with common inventors as the current application.

### FIELD OF THE INVENTION

The present application relates to the field of network-based book publishing. More particularly, the described embodiments relate to a system and method in which users access books page by page through a computerized web server, with a social community oriented around each book being presented in conjunction with the reading of the book.

### BRIEF DESCRIPTION OF THE DRAWINGS

FIG. 1 is a block diagram showing a computerized system in use with a plurality of users, authors, and publishers.

FIG. 2 is a block diagram showing a server computer operating a web server to present interfaces over the World Wide Web.

FIG. 3 is a block diagram showing user related database elements.

FIG. 4 is a block diagram showing author related database elements.

FIG. 5 is a flow chart showing a method for monitoring user interaction with a web-based book reading system.

FIG. 6 is a flow chart showing a method for determining user completion and defection status.

### DETAILED DESCRIPTION

### Overview

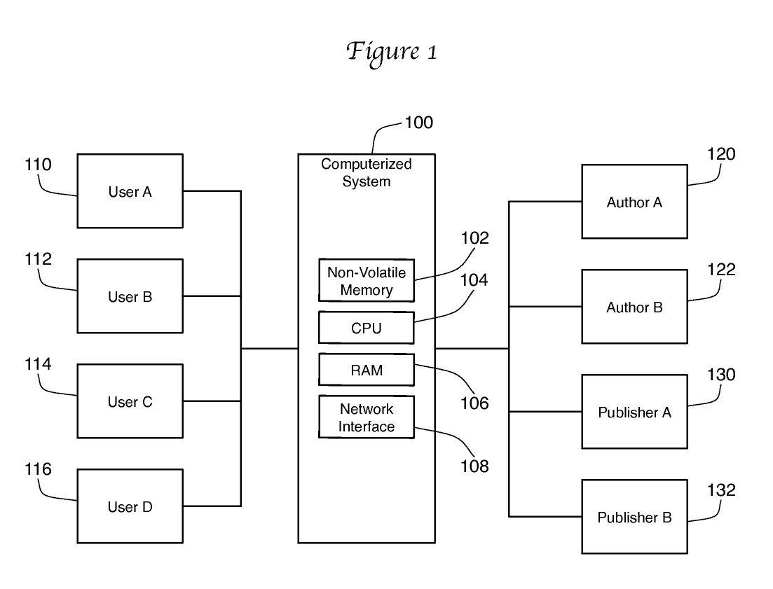

FIG. 1 is a block diagram showing a plurality of users 110-116, authors 120-122, and publishers 130-32 that are connected through a computerized system 100. The computerized system 100 provides an interactive interface to users 110-116 that allows users to page through and read one or more books. In the present description, users 110-116 are those individuals who use the computerized system 100 to read a book, to review information and content about the book, and to interact with other parties concerning that book. Authors 120-122 are those individuals who authored the books that are available for reading on the system 100. Publishers 130-132 are the entities that publish the printed version of the books, or entities that otherwise assist in the publicity for or distribution of the books.

In this description, the term author, publisher, and book are used to describe an embodiment of the present invention. However, it is not necessary that the material being read by a user constitute a book per se. For instance, the content may be a journal article, a news report, etc. The authors using the system would not then be book authors or publishers, but could be a writer, journalist, or any other type of content creator. The publisher also need not be a written book publisher, but could be any entity that works on publicity or distribution of the written content. Consequently, the word book should be construed broadly to mean written content, the word author should be construed to mean the creator of the written content, and the word publisher should be construed to mean an entity involved in publicity or distribution of the written content.

The computerized system 100 includes a set of software instructions or interfaces stored on a non-volatile, non-transitory, computer readable medium 102 such as a hard drive or flash memory device. A digital processor 104, such as a general purpose CPU manufactured by Intel Corporation (Mountain View, Calif.) or Advanced Micro Devices, Inc. (Sunnyvale, Calif.) accesses and performs the software. To improve efficiency, processor 104 may load software stored in memory 102 into faster, but volatile RAM 106. Data operated upon by the software can also be stored in non-volatile memory 102 and retrieved into RAM 106 for analysis, recording, and reporting. The computer system 100 further includes a network interface 108 to communicate with other computerized devices across a digital data network. In one embodiment, the network is the Internet or an Intranet, and the network interface 108 includes TCP/IP protocol stacks for communicating over the network. The network interface 108 may connect to the network wirelessly or through a physical wired connection. Instead of being a single computer with a single processor 104, the computerized system 100 could also implemented using a network of computers all operating according to the instructions of the software.

By using the computerized system 100, users 110-116 not only receive access to the book that they wish to read, but they also participate on a social community related to that book. Unlike many other computerized social networks, the community created by the computerized system 100 is oriented around a particular book. By organizing the community in this manner, the system is able to combine the act of reading a book with interaction with that book's social community. The social communities created by the computerized system 100 include content created by, and interaction between other users 110-116 who are also reading the book, the author or authors 120-122 of the book, and other entities such as publishers 130-132 who are publicizing and attempting to generate interest in the book.

For instance, user A 110 may be interested in reading a particular book using the computerized system 100. In this example, the author of the book, author A 120, has decided to use the computerized system 100 to distribute her book and to reach out to the community of users reading her book. Author A 120 likely made the decision to use the computerized system 100 with the advice or consent of her publisher, namely publisher A 130. Author A 120 and publisher A 130 work together to provide access to the book using the customized interfaces of system 100. User A 110 purchases the right to read the book, and is given full text access to the book through the user's own interface to the computerized system 100. User A 110 is also given access to book related supplemental materials, updates, and blog posts created by the author A 120 and publisher A 130. At the same time, other users 112-116 also purchase the right to access the book and receive access to the same materials provided by the author 120 and publisher 130.

While reading the book, user A 110 may wish to make a note about a particular page in the book. By using the computerized system 100, user A 110 may make a private note for later review of user A 110, or can add that note publicly to the social community organized around the book. Assuming that the note has been made public, user B 112 may read that note when reaching the same page in the book, and can respond either directly to user A 110 or to the community as a whole about that note. User C 114 may read the same page and then generate an unrelated note for the next reader. In this way, participants in the community surrounding the book generate additional content that becomes valuable for future users, such as user D 116. As this cognitive surplus for a book develops, users 110-116 will begin to turn to the computerized system 100 as much for the book's community and related content than for simple, full text access to the book's content.

Even after submitting a book for distribution, author A 120 may return frequently to the computerized system 100 to participate in the communities that have developed around her books. Such participation may be of personal interest and enjoyment to the author, while also helping to increase interest and readership of the author's books. In addition, author A 120 may request statistics concerning user interaction with the book. The computerized system 100 can respond by informing the author 120 of the total number of users who have purchased access to the book, the number of active readers, the number of notes left for the book, and other statistics related to the book. In addition, by tracking user interaction with the particular pages of the book, the computerized system 100 can provide author A 120 with valuable insights into the way users perceive different parts of the book. For instance, the computerized system 100 can indicate the pages that contain the greatest number of notes and the greatest amount of interaction between users 110-116. By tracking the time spent on particular pages, the computerized system 100 can also inform the author 120 which pagers users read quickly, and which pages users read slowly. In fact, by tracking pages read over time, the computerized system can determine whether a user has effectively abandoned the reading of a particular book, and the page where the user stopped reading the book (the user's “defection point”). Similar statistics can be made available to publishers 130-132 about their books, allowing both authors 120-122 and publishers 130-132 to obtain valuable feedback on the particular strengths and weaknesses of various books based on actual monitoring of user reading habits.

### Implementation as a Web Server

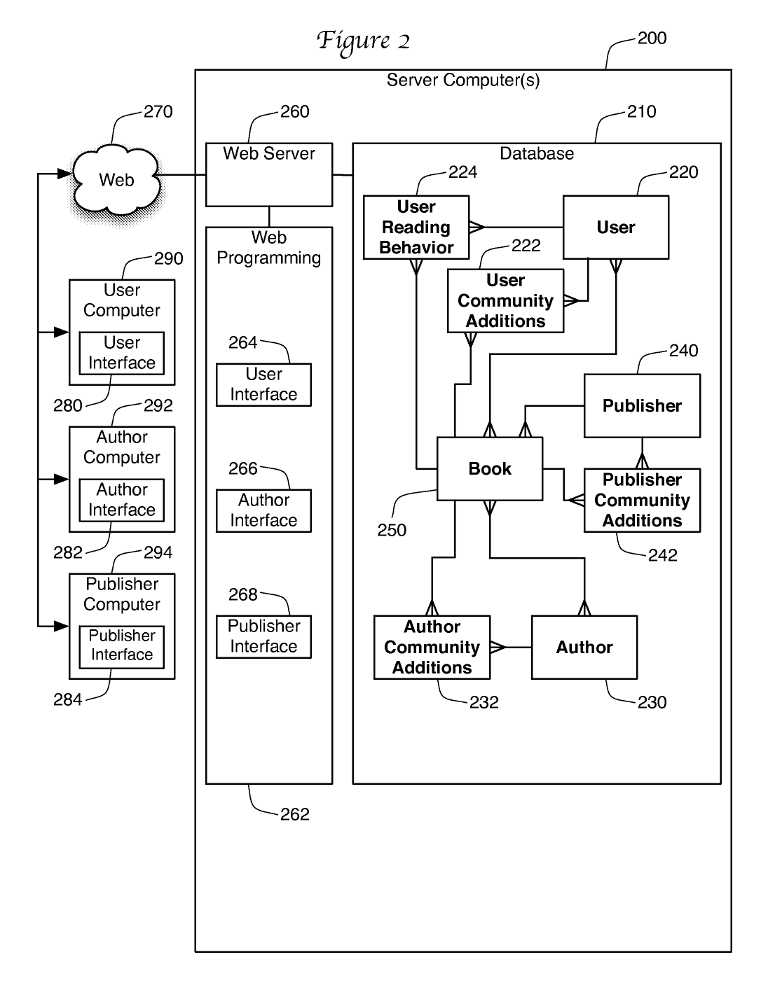

The computerized system 100 of FIG. 1 can be implemented as one or more web server computers 200 as shown in FIG. 2. The computerized system 200 is capable of storing information about all of the parties that use the system 200. In the preferred embodiment, this information is stored by the server computer 200 in a database 210. This information can be maintained as separate tables in a relational database, or as database objects in an object-oriented database environment within the database 110. FIG. 2 shows the database 210 with tables or objects for users 220, authors 230, publishers 240, and books 250. This allows the database 210 to maintain information about the users 110-116, authors 120-122, and publishers 130-132 that may access the server computer 200. Of course, the table or object entities shown in FIG. 2 should not be considered to show actual implementation details of the database 210, since it is well within the scope of the art to implement this type of data using a variety of entity architectures. The entities shown are exemplary, intended to aid in the understanding of the data maintained by the system database 210 in this embodiment. For example, it would be well within the scope of the present invention to divide information about users 220 into multiple tables or objects, instead of the single user entity 220 shown in FIG. 2. Similarly, it would be possible to implement the database 210 such that information about users, authors, and publishers all use a single database table or object, where the role (user, author, publisher) for each instance is defined using a field within that table or object. Finally, it is not even necessary to implement these entities as formal tables or objects, as other database paradigms could also effectively implement these types of data structures.

Relationships between these entities 220-250 as well as the other entities in the database 210 are represented in FIG. 2 using crow's foot notation. For example, FIG. 2 shows that a book 250 may have multiple authors 230, but only a single publisher 240. Each author 230 and publisher 240 can, in turn, have multiple books 250. Users 220 in the database 210 can be associated with multiple books 250, and each book 250 can itself be associated with multiple users 220.

The database also tracks the contributions made to the community surrounding a book 250 by each of the various participants. For instance, each user 220 can make multiple user community additions 222 to the system 200. These additions 222 may include page notes, chapter comments, book reviews and ratings, chat room contributions, etc. While each user 220 may make user community additions 222 about any book 250 with which they are associated in the database 210, each user community addition 222 is related to only one particular book 250. Similarly, each author 230 may make author community additions 232 to the database 210, thereby allowing the author 230 to make comments, updates, and blog posts about one of their books 250. In one embodiment, each author addition 232 is associated with only a single book 250, as shown in the crow's feet notation of FIG. 2. In other embodiments, authors 230 are granted the ability to make author community additions 232 that are associated with multiple books 250. For instance, the author 230 may maintain a general blog 232, which the author 230 wishes to make available to users 220 of all of the books 250 authored by that author 230. Alternatively, the author may have a blog that is associated with a particular series of books (i.e., the historical mysteries) written by the author but is not associated with other books by that same author. Similarly, publishers 240 may make publisher community additions 242 relating to their books 250. The various community additions 222, 232, 242 that are associated with a book 250 together constitute the social community oriented around that book 250.

Users of the system 200 are given access to a book's content by associating their user record 220 with the appropriate book record 250 in the database. The text of the book is stored in the book record 250 or in related database records. Users whose record 220 is associated with the book 250 are granted access to the books' related community additions 222, 232, 242.

User interaction with the book's content through the sever computer 200 are stored in user reading behavior records 224. These records can indicate when a user purchased a book, or started reading that book. Additional records can track each page turn (or “page clicks”) by the user. Only by tracking user interaction with a book at the page level can some of the most useful information about the book and the user be generated.

The database 210 is used by a web server 260 operating on one or more of the server computers 200 to generate the various interfaces used by the system 10. In particular, web programming 262 exists that defines how to create a user interface 264, an author interface 266, and a publisher interface 268 using the data in the database 210. This programming 262 allows the web server 260 to transmit over the World Wide Web 270 (or an intranet) a user interface 280 that can be seen by a browser operating on a computer 290 for the benefit of a user. Similarly, the web server 260 can manage an author interface 282 on browser operating on an author computer 292, and a publisher interface 284 operating on a publisher computer 294. Each computer 290, 292, 294 could be a standard personal computer operating a Microsoft Windows, Linux, or Apple Mac OS operating system. Alternatively, these computers 290-294 could be mobile devices, such as smart phones or tablet computers, operating Google Android, Apple iOS, or Microsoft Windows Phone operation system. In addition, the device could be a “smart” or Internet enabled television.

### User Related Data

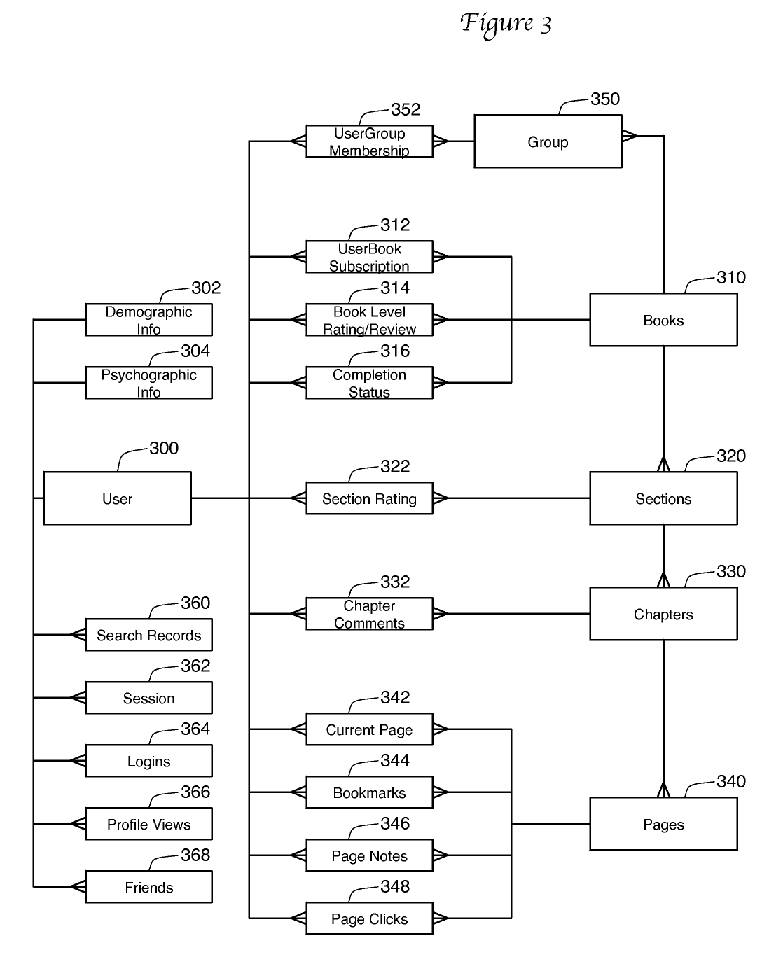

FIG. 3 shows the database elements 300-368 used by the database 210 to track information about users and their interactions with books. The user database element 300 is connected to the book element 310 primarily by the UserBook subscription 312. This element 312 indicates that the user 300 has purchased or otherwise obtained access to the book 310. For instance, the system could be designed so that users purchase subscriptions to books one at a time. Those subscriptions could be permanent, or could require that a user pay for a renewal after a given time period. Alternatively, the system could allow users to purchase unlimited access to books for a limited time period. The user would then select a book that she wishes to access, and the system would then create a UserBook subscription entry 312 assigning the book to that user. Relationships between entities in FIG. 3 can be established using any of the standard techniques known in the field of database design. In the present case, a unique user ID is assigned to each user entry 300, and a unique book ID is assigned to each book entry 310. All other entities that relate to the user 300 or book 310 make that relationship using the user ID or book ID, respectively.

User information, such as the user's name, address, username, password, etc. is stored in the user database element 300. Related records can also be created to store similar information. For instance, the database elements in FIG. 3 separate demographic info 302 (such as age, sex, geographic location, and income) and psychographic info 304 (such as reading preferences and past purchasing behavior) into separate elements from the user 300, even though it would be a simple matter to integrate this same information into the definition of a user table or object 300. The book element 310 itself contains information about the book (such as the book's title, date of copyright, ISBN number, etc.), although such data could also be located in separately defined database elements.

In the preferred embodiment, users 300 who have finished reading a book 310 are permitted to create a book rating and review 314 for the book 310. Users 300 who have not completed the book 310 may leave comments about parts of a book, but may not created a book level rating or review 314. The completion status detailing a user's interaction with a book is stored in database element 316.

In the embodiment shown in FIG. 3, books 310 are conceptually subdivided into sections 320. Sections 320, in turn, are subdivided into chapters 330, which are made up of pages 340. Each of these portions is represented by separate database elements. In the preferred embodiment, the actual content or text of the book 410 is stored in the page level database element 440. One of the primary advantages of these subdivisions is that user community additions relating to this book can be associated with the particular subdivision. For instance, users 300 are allowed to create separate section ratings 322 for each section 320, and to create chapter comments 332 for each chapter 330. Another advantage of this hierarchy system is that it allows for the smallest subdivision of a book to be defined at the page level. By keeping the book's content at this level 340, user interaction with each page can be easily monitored and analyzed. Furthermore, segmentation of the book 310 down to the page level 340 is instantly familiar and comfortable to all users 300.

On the page 340 level, the database tracks the current page 342 being reviewed by the user. By separately storing this information, the system allows a user to quickly return to their place within a book at later time, even after a significant delay between reading sessions. Locations in the book 310 of particular interest to a user can be marked using bookmarks 344. In some embodiments, simple notes or a title describing the bookmark 344 can be stored along with the page information in the bookmark entity 344. In the preferred embodiment, bookmarks 344 created by one user can be shared with other users, so that one user can see where another has bookmarked a particular book.

One of the significant advances of the present invention is its ability to allow a user to create notes 346 that are relevant to a particular page 340. Using this construct, later readers of the same book 310 can access page level notes 346 left by earlier readers, but only when the later readers reach that page. The page level notes data structure 346 can contain the actual note left by the user, as well as the user's preferences about the note. For instance, the user can designate that the note is a private note that should be viewed only by the user, or designate that the note is public, thereby allowing the system to share the note with all readers reaching that same page 340 of the book 310. In the preferred embodiment, public notes are accessible to all users 300 of the book 310, thereby allowing communication between otherwise unrelated users 300. In one embodiment, page notes 346 can relate to other notes 346, thereby allowing the creation of threaded, back-and-forth discussions within the book's community.

In another embodiment, the user can participate in a book's community as part of a group 350. A group is a subset of all users that are reading a particular book 310. In this embodiment, a third option of sharing page notes 346 can be presented, where notes can be viewed by members of the group 350 but not by other readers of the book 310. The membership of a user 300 in a group 350 is defined by the UserGroup membership database entity 352.

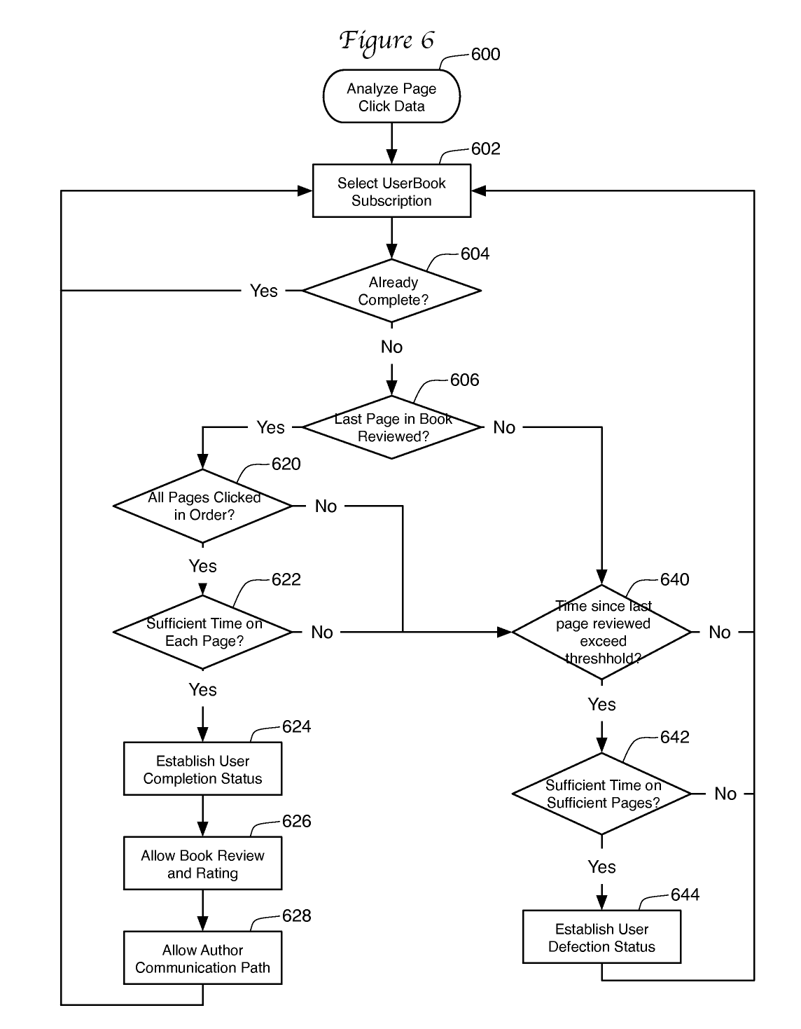

Another advance made by the present invention relates to the ability to track page clicks 348. Page click entries 348 detail when a user 300 requests access to a particular page 340 of a book 310. An analysis of page click records 348 can determine whether a user 300 has completed reading a book 310, which could then be recorded in the completion status record 316. This analysis is described below in more detail in connection with FIG. 6. Page click records 348 can also be used to determine defection points where a user 300 has stopped reading a book 310, or places where a user either skimmed a page briefly or spent significant time slowly reading through the page. Page clicks are also useful to generate reports or “heat maps” concerning the popularity of particular pages or portions (groups of pages) in a book. An author can request that a report be generated indicating the number of page clicks recorded for different pages in their book, either for all users or for a particular subgroup of users. If the report is generated in the form of a heat map, the author can see the valleys, plateaus, and mountainous regions generated by the clicks of different pages.

Page clicks 348 can even determine where a user 300 decided to look back through previous pages 340 in the book 310. Such information could be useful to an author, as it may indicate a location where the book 310 has become more confusing. Similarly, one embodiment of the present invention may record all search requests 360 made by a user 300. Search requests may relate to a particular book 310, or may be made over multiple books 310. It is even possible that search request could be made relating to books not yet subscribed to by a user 300 (as indicated by subscription link 312). By tracking the timing of a search request, it is possible to identify users 300 who are stuck at a particular page in a book who then search for references to a character or an idea earlier in the book. While some embodiments of the present invention would not share all search requests 360 made by users with authors, some sharing of this information will allow authors to see not only where (i.e., what page) cause the user confusion, but also the search request made by the user 300 to clarify the confusion.

In addition to page clicks 348 and search records 360, it may be useful to record user interaction with page notes 346 or similar community additions. For instance, each time a user requests to view the page notes 346 (or chapter comments 332 or book review 314) of another user, the database 210 could track this viewing. This would help analyze which pages inspire (or otherwise encourage) a user to look for additional content from the community. This would help the author and publisher identify pages of strong interest (or confusion) among users. In addition, such tracking would help the system identify the users whose contribution to the community were most valued by other users.

Other types of user related data can also be maintained in the database, including a record of user sessions 362 and logins 364. Sessions 362 are used to keep track of a user's online status. If a session 362 is deleted, the user is automatically logged off the site. A user session 362 is only initiated after a successful login 364. Logins 364 track in the database 210 how often a user has logged into the site, and when they last logged in. Logins 364 also track failed logins, allowing the computerized system to create failsafe mechanisms that can suspend an account after a preset number of failed login attempts. In addition to sessions 362 and logins 364, the present invention also stores cookies in the web browser of the users, authors and publishers. Cookies can be used to store encrypted data indefinitely in those browsers, so that the users do not have to re-enter their login credentials.

The system also maintains records of user interactions with other users, such as when one user views the profile of another user (profile views 366), or when one user befriends another (record 368). As seen in other social networking environments, the linking of users 300 with friends allows users 300 to explore the interests and activities of their individually selected friends.

### Author and Publisher Related Data

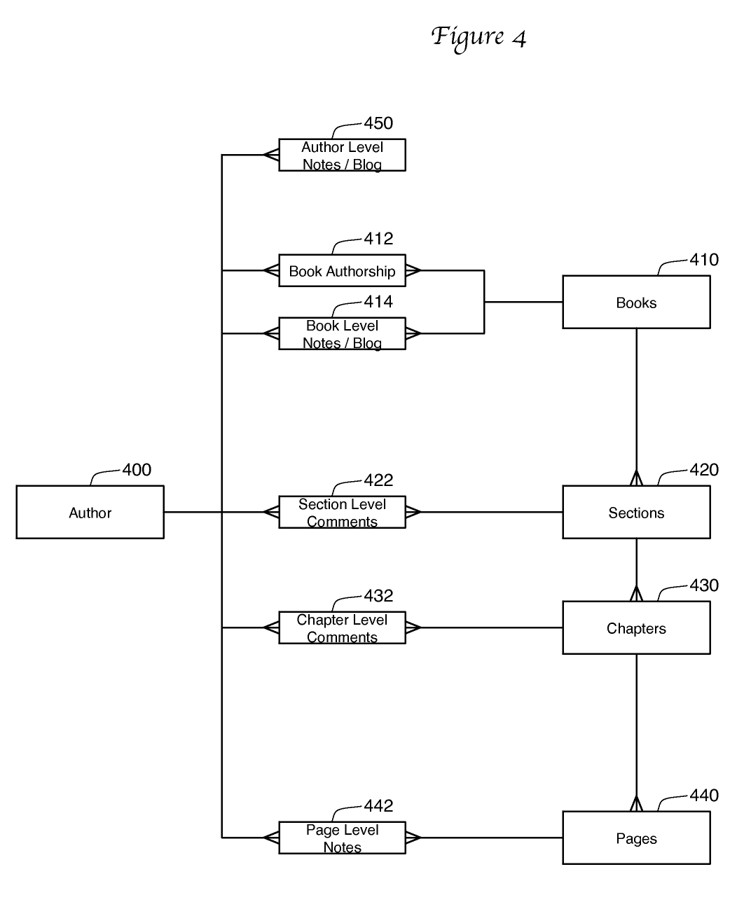

FIG. 4 shows the database elements 400-450 used by one embodiment of the present to track information about authors 400 and their authored books 410 that are distributed by the system. As seen in this figure, the books 410 can be associated with subcomponents, namely sections 420, chapters 430, and pages 440. Although distinct item numbers are used in FIGS. 3 and 4, it is contemplated that the books 410 and related subcomponents 420, 430, 440 of FIG. 4 could be implemented as the same database entities as the books 310 and related entities 320, 330, 340 of FIG. 3.

The system creates a relationship between an author 400 and a book 410 by creating a book authorship entity 412 that links these two records. Each author 400 is allowed and encouraged to submit community additions relating to their books 410. In the embodiment shown in FIG. 4, the author can create book level notes 414 that relate to the entire book 410. These notes 414 can take the form of one-time notes, much like an author's forward to the published edition of a book. Alternatively, the book level notes 414 can be implemented in the form of a blog, allowing the author to make frequent contributions to the community. As with other blogs, the author's book level notes 414 can allow dialog with readers of the notes 414, with users commenting on the notes 414 and also on other users' comments to the notes 414.

In addition, the author 400 may choose to add section level comments 422, chapter level comments 432, and page level notes 442 that relate to the book's sections 420, chapters 430, and pages 440, respectively. By subdividing author community additions in this manner, it is possible to limit access to those contributions to only those users currently viewing the relevant section, chapter, or page. While it is unlikely that the author would care to maintain blog-type notes on the section, chapter, or page level of their books, such capabilities are contemplated by the present invention. In other embodiments, the author is allowed to contribute only book level notes 414 to the community.

An author 400 may also wish to make certain contributions applicable to more than one book at time. These contributions are shown in FIG. 4 as author level notes or blogs 450. These types of notes 450 are automatically associated with multiple books 410 created by the author.

In addition to author related community contributions, the present invention also includes publisher related contributions. Much like the contributions of an author, these contributions can relate to an entire book, or to a specific section, chapter, or page of a book. While no figure shows these publisher contributions, the relationship between these contributions and the various hierarchy levels of a book would be the same as shown in FIG. 4 with respect to authors.

### Methods of Operation

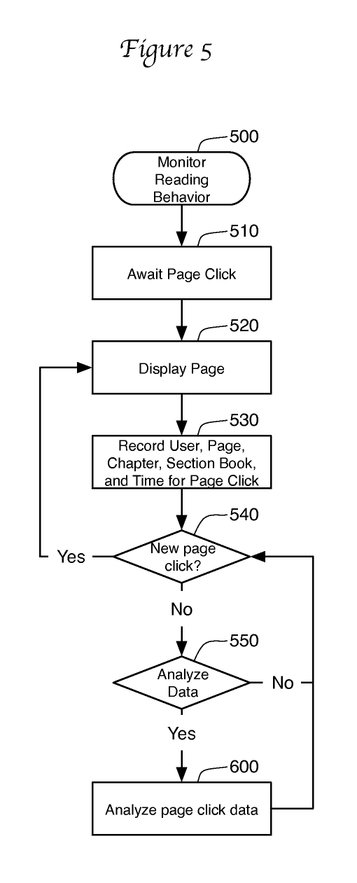

FIG. 5 contains a flow chart showing the method 500 for monitoring reading behavior used by the above-described embodiment. The first step 510 is to await a request from a user to view a new page of a book. This request can come sequentially, such as when a user viewing page ten of a book requests page eleven as the next page. The request can also be a request to page backward through the book, which may be desired if a user wishes to review what just happened in a story. The request may also come as part of a search request, where the user requests to see a particular page after searching for a character name or key word in a story.

When a page click or request has been received, the system not only provides the new page to the user at step 520, but also records data about the page click in the database at step 530. This information includes the identity of the user and book, the particular page involved, and the time at which the page has been requested. At step 540, the method then determines whether a new page click has been received. If so, the next page is displayed again at 520 and data about this new page click is recorded at step 530.

When no click is received at step 540, the method determines at step 550 whether there is a need to analyze the page click data. The analysis of page click data could occur periodically, such as every evening or every two hours. Alternatively, the page click data could be analyzed only when a report that uses such analysis is requested. If analysis is required, a process for analyzing page clicks 600 is performed. This process 600 is described below in connection with FIG. 6. After the analysis 600 is completed, or if no analysis is to be done, the processes returns to waiting for a new page click at step 540.

As shown in FIG. 6, the process 600 for analyzing page click data 348 begins by selected a particular UserBook subscription record 312. The primary purpose of analyzing page click data 348 is to determine how a user has interacted with a book, and the user's current status in reading the book. To analyze all data in the system, each subscription 312 linking a user 300 to a book 310 would be analyzed by analyzing all of the page clicks 348 made by the user in that book. Of course, in some circumstances only a subset of all the data need be analyzed. For instance, if data is being accumulated for an author, only subscriptions relating to books authored by the author need be analyzed.

Once a particular UserBook subscription 312 has been identified, the process next determines at step 604 whether all the necessary analysis for this subscription has already been completed. For example, the data structures in FIG. 3 show a completion status data entity 316 that is maintained for each subscription 312 of a book 310 by a user 300. This status 316 may indicate, for example, that that the user 300 has successfully completed the book 310, indicating that all of the page clicks 348 that the user 300 entered with respect to this book 310 have already been analyzed by the system.

Once a subscription is identified needing analysis, step 606 determines whether the user has already viewed the last page in the book. This can be determined by searching for page clicks 348 by the user 300 relating to that last page 340. If so, it is possible that the user has successfully completed the book. In order to make certain, the process then determines at step 620 whether the user has viewed all of the pages 340 of the book 310 in order. This can be accomplished by ensuring that the page click records 348 for the subscription include all pages 340 of the book 310, and that the timestamps in those records 348 are consistent with viewing the pages 340 in order. In some embodiments, this determination 620 can allow for some variations in completions, such as determining that a user read all the pages even though two pages actually remain unread. This flexibility allows for unexpected peculiarities in books, such as blank pages or photography pages in the book that were deliberately skipped by the reader. In the preferred embodiment, a user who reads at least 95% of the pages of a book is considered to have read all of the book.

Even if all the pages 340 in the book 310 were clicked in order, the process 600 still needs to ensure that each page 340 was actually read by the user as opposed to simply being “clicked-through” without reading. This is accomplished in step 622 by comparing the timestamps found on the page click records 348 of consecutive pages. If this analysis indicates that sufficient time was spent on each page, then the user is assumed to have read the page. The amount of time may be set for all pages (i.e., 40 seconds per page), or may be set according to the number of words found on each page. Of course, since page click record 348 includes only a single time stamp, the time spent on a page 340 is determined by comparing the time stamp for that page 340 with the time stamp of the next chronological page click record 348. As with test 620, test 622 allows some variations to account for peculiarities within a book. For instance, blank pages between chapters may be reproduced in the book, or each starting or ending page of a chapter may contain only a partial page of text. One embodiment performs statistical analysis on the time spent on each page 340, and uses the median or mean reading time to determine whether the pages 340 as a whole have been read. In yet another embodiment, the method 600 may allow a user to read all or a portion of a book offline. For instance, a user may have previously read a book, and has subscribed to the book using the computerized system 100 simply to participate in the community surrounding the book. To allow such users to submit a book-level review of the book, some embodiments may allow a user to bypass steps 620 and 622.

Assuming tests 620, 622 indicated that the user has successfully completed the book, step 624 records this determination in the completion status record 316. At step 626, the user 300 who completed the book 310 will then be granted the ability to submit a full book review and rating 314 for the book 310. By requiring this analysis before the user 310 can submit such data 314 to the system, the integrity of those reviews and ratings 314 can be increased. In some embodiments, users 300 that complete a book 310 are also granted access to a communication path to the author of the book 310 in step 628. This allows a user to make suggestions or comments directly to author. By requiring book completion before opening this pathway, the author can be assured that these communications are only coming from users 300 that have completed the book 310. After opening this communication path, the process returns to step 602 to select a new UserBook subscription 312 for analysis.

If step 606 determines that the last page in the book has not yet been viewed, or if the analysis fails test 620 or 622, the method continues at step 640 in order to determine whether the user 300 has abandoned their effort at reading the book 310. At step 640, it is necessary to determine whether the most recent page click 348 associated with this subscription occurred long enough ago as to exceed a predetermine time threshold. For example, if a user has reviewed any page in a book within the last ninety days, the user 300 will not be considered to have abandoned their reading of the book 310. In this case, the process 600 returns to step 602 to select a new UserBook subscription 312 for analysis. If it has been longer than the established time period (i.e., ninety days), step 642 then determines whether the user 300 undertook enough steps as to be considered to have started the book 310. For instance, users 300 may purchase access to multiple books 310 at a time, but then examine only the first page or two of most of the books 310 to see if access was successfully granted. Although the time of the most recent page click 348 may then eventually exceed the time threshold, it would be inappropriate to consider this user 300 to have abandoned reading the book 310 since they have not effectively started the book 310. Thus, if step 642 determines that the user 300 has not devoted sufficient time on the book 310, or reviewed sufficient pages 340 to be considered to have started the book 310, the process will simply return to step 602 to select the next subscription 312.

If steps 640 determines that the user 300 has stopped reading the book 310, and step 642 determines that the user 300 had started the book 310, then 644 will the record the fact that the user 300 has abandoned the book 310. The last page read by the user 300 will then be considered the defection point, and this information will be recorded in the database (such as within the completion status information 316). Once step 644 is completed, the process returns to step 602. Of course, if the user 300 then re-starts the book 310, it would be important to erase the defection point and the abandonment status. Alternatively, status information about abandonment of a book does not have to be recorded in the database. Rather, this information can simply be generated every time a report is created needing this information. In this embodiment, only the completion status 316 would be recorded as data within the database.

Note that it is not necessary that the data maintained by the system be implemented exactly as shown in the figures. In FIG. 3, the UserBook subscription entity 312 and the completion status 316 are shown as separate entities, both of which are related a single user 300 and a single book 310. In an alternative embodiment of the present invention, these two database entities 312, 316 could be easily combined. Similarly, it is not necessary that all elements of process 500 or 600 be implemented in the same steps shown in the figures. For instance, a single search that limited the selection of UserBook subscriptions 312 to subscriptions needing to be analyzed would eliminate the need for a separate step 604. Alternatively, the end of book analysis 620-628 described below might be independently triggered whenever the last page in the book is reached by a user, thereby obviating the need for steps 602-606.

The information stored in the database 210 as supplemented by the analysis in process 600 can be used to generate information of great worth to authors and publishers. Some of this information is set forth in the following table of useful data that can be made available on data analysis reports:

TABLE 1
Available Data

User ratings for books that are limited only to those users that actually
read the book
Number of users who purchased access to a book (i.e., subscribers)
Number of users who started reading a book (reflected as a raw number
and a percent of subscribers)
Number of users who completed a book (reflected as a raw number, a
percentage of subscribers, or a percentage of users who started the book)
Number of users who abandoned reading a book (reflected as a raw
number, a percentage of subscribers, or a percentage of users who started
the book)
Comparison of users who completed the book versus users whohave
stopped reading the book
The ratings for particular sections of a book
The chapters of a book for which users have generated the most comments
The pages of a book for which users have generated the most notes
The pages of a book for which users have read the most notes by others
The pages of a book from which users have requested the most searches,
or have requested a previous page
The pages of a book where the most user defections occurred
The pages of a book where users spend the most or least time reading
(which can be normalized according to number of words on a page)
The number of men/women between the ages of (15-23)/(50-65) living in
Canada or the United States in the Pacific Time Zone who have subscribed
to the book.
The percentage of subscribers of an author's previous books that have
purchased a subscription to the author's most recent book.

Some of the above data can be taken directly from the database 210, while other data is extracted from the analysis process 600. Still other data is accessible by additional analysis. For instance, to determine which pages are most likely to lead a user to generate a search request, the timestamp values on the page click records 348 and the search records 360 could be compared. In addition, any of the information in the above table can also be filtered or otherwise organized according to the demographic info 302 or the psychographic info 304 of the users. From such information, a publisher may discover that a certain book appeals very strongly to young males who have previously purchased fantasy novels (with a high completion rate and a low defection or abandonment rate). The same book, however, appears less satisfactory to slightly older males who read both fantasy and mysteries (as shown by a higher defection rate). The data could even show the publisher the portion of the book (the pages) where the defection rate was highest. Note that this distinction in defection rates between different demographic/psychographic groups can be made by the present invention even though both groups seem to purchase the book in equal numbers. Similar reports could identify differences based on geographic location. Such geographic information could be based upon self-reporting, IP address analysis, or geolocation information provided by the user computing device 290.

Regardless of the source, this data is extremely valuable to authors and publishers. The author interface 282 and the publisher interface 284 could both provide access to all of this data for all books associated with the author or publisher. Alternatively, some of the data could be reserved for only premium subscribers who pay for full statistical analysis. In addition, much of this data could be provided to users who are searching for a new book. Users could determine through their user interface 280 the completion vs. abandonment percentage for previous readers of the book, and thereby learn how previously users responded to the book before purchasing access to the book. Users could also use this data to see which parts of the book need community addition content in order to add content to those portions, or to see which parts of the book have a large number of community additions to ensure that the user spends more time in those portions of the book.

In the above description, the data stored in the database 210 as individual book pages 340 are provided to users through an interface provided by a web server 260. However, one benefit of storing books in page level entities 340 is that it is possible to “stream” the pages like an RSS feed via any RSS feed reader. These pages 340 can also be syndicated on third party sites the way a YouTube video or Google analytics is syndicated, namely via JavaScript code that is embedded on different sites. Furthermore, the computerized system 100 can also convert the text stored in the page entities 340 into various graphical formats with added security, which allows for customization of the interface for each syndication partner's site. These benefits are only possible and practical if the content is stored in this manner.

Of course, the system and methods described above are exemplary and are not the exclusive techniques for using the disclosed embodiments. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method of presenting a book to a user for reading comprising:
a) storing the content of a book as separate pages in a computerized database;
b) presenting the separate pages to the user through a user interface created by a web server operating on a server computer;
c) tracking user interaction with the user interface, specifically tracking page clicks requesting a new page in the book; and
d) analyzing at the server computer the page clicks to verify that a user has read the book.

2. The method of claim 1, wherein the step of analyzing page clicks comprises determining that the user has viewed a certain number of pages in the book.

3. The method of claim 2, wherein the certain number is determined with reference to the total number of pages in the book.

4. The method of claim 3, wherein the certain number is the same as the total number of pages in the book.

5. The method of claim 3, wherein the certain number is at least ninety-five percent of the total number of pages in the book.

6. The method of claim 2, wherein the step of analyzing page clicks further comprises analyzing the time spent by the user on each page.

7. The method of claim 6, wherein the step of analyzing the time spent on each page further comprises comparing page click records in the computerized database.

8. The method of claim 7, wherein each page click record identifies a particular user, a particular book, a particular page in the particular book, and contains a time stamp.

9. The method of claim 8, wherein the step of comparing page click records comprises comparing a first time stamp on a first page click record with a second time stamp on a second page click record, wherein the second page click record is the next page click record chronologically for the particular user and the particular book.

10. The method of claim 1, wherein the step of analyzing page clicks further comprises analyzing the time spent by the user on each page.

11. The method of claim 6, wherein the step of analyzing the time spent on each page further comprises comparing page click records in the computerized database.

12. The method of claim 7, wherein each page click record identifies a particular user, a particular book, a particular page in the particular book, and contains a time stamp.

13. The method of claim 8, wherein the step of comparing page click records comprises comparing a first time stamp on a first page click record with a second time stamp on a second page click record, wherein the second page click record is the next page click record chronologically for the particular user and the particular book.

14. A method of presenting a book to a user for reading comprising:
a) storing the content of a book as separate pages in a computerized database;
b) presenting the separate pages to the user through a user interface created by a web server operating on a server computer;
c) tracking user interaction with the user interface, specifically tracking page clicks requesting a new page in the book; and
d) analyzing the page clicks to determine that a user has ceased reading the book.

15. A system for presenting a book to a user for reading comprising:
a) a processor for processing software instructions;
b) a tangible, non-transitory memory containing software instructions;
c) a database containing entities for users and books,
wherein book records include individual page records;
wherein the content of the book is stored in the individual page records; and
wherein the software tracks user interaction with the page records, with the software recording in page click records each request of a user to access a new page from the book, the page click records including an identifier for the user, the book, the page, and a time.
